(19) United States
(12) Patent Application Publication
(10) Pub. No.: US 2005/0091817 A1
(43) Pub. Date: May 5, 2005

(54) Method for the quantitative determination of the dynamic seating comfort of a seat padding

(76) Inventors: Michael Eger, Haigerloch (DE); Lothar Kassing, Nufringen (DE); Karl Pfahler, Stuttgart (DE); Lothar Renner, Nufringen (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/491,489

(22) PCT Filed: Aug. 21, 2002
(86) PCT No.: PCT/EP02/09302

(30) Foreign Application Priority Data
Oct. 2, 2001 (DE) 101 48 662.6

(51) Int. Cl. B23Q 17/00; G01M 19/00

(52) U.S. Cl. 29/407.07; 29/407.01

(57) ABSTRACT

A method for determining an evaluation number which is representative of the quality of the dynamic sitting comfort of upholstered seat elements of a vehicle seat. A flexible measuring mat is applied to the upholstered seat element in a defined position and a matrix, which covers the surface, of force measuring sensors which operate without hysteresis is integrated into said measuring mat. A test person or a test body which behaves anthropomorphically in terms of oscillation is positioned on the vehicle seat. In order to carry out a measurement, this body/seat system is excited so as to oscillate, for example by traveling over a bad stretch of road. The signals supplied by the force measuring sensors are added with the same phase to form a composite signal. The frequency response of the body/seat system is determined from this composite signal.

This application claims the priority of German Patent Document No. 101 48 662.6, filed 2 Oct. 2001 and PCT/EP02/09302 filed 21 Aug. 2002 the disclosure of which is expressly incorporated by reference herein, respectively.

The invention relates to a method for quantitively determining the dynamic sitting comfort of upholstered seat elements.

When developing seats, in particular vehicle seats, one of the important factors is to achieve a high degree of sitting comfort because the vehicle occupants, especially the driver, must, precisely in the case of vehicle seats, in some cases stay seated for many hours with little movement. In such a situation, questions of optimum seat pressure distribution, among other things, play a significant role. The behavior of a seat is determined by a plurality of factors, as for example by type, design and fabrication of the multilayer composite structure of the covering material as well as the material, type and design of the support structure of the seat, and by other similar factors. If the seated pressure of an upholstered seat element is distributed unfavorably it will be unpleasant and uncomfortable if the person is seated for a relatively long time.

In the course of the development of a seat, different designs of the seat and of the upholstered elements are produced as trial samples which must be compared with one another objectively and in a reproducible fashion with respect to different testing and evaluation criteria and also with respect to the pressure comfort so that the best trial sample can then be selected. Not only new trial samples of a current development of a seat but also different test seats from a different provenance, for example seats from earlier generations of seats, used seats or seats from outside development or fabrication workshops are compared with one another.

According to a known method disclosed in German Patent Document DE 196 01 974 C2 (referred to below for short by [2]) for quantitively determining the sitting comfort of upholstered seat elements, the distribution of the sitting pressure is measured statically between a test ram of anthropomorphic design and the upholstered seat element to be tested. A thin and flexurally weak measuring mat with a plurality of separate pressure sensors integrated into the measuring mat, distributed in the manner of a grid so as to cover the surface and are also inherently flexible, are placed between the upholstered surface and the test ram. The signal outputs of the pressure sensors are connected to an evaluation device. While the sitting surface of the upholstered seat to be tested is loaded statically, under realistic conditions, by a force corresponding to the sitting weight of an average person, the signals of the individual pressure sensors of the measuring mat are evaluated and an evaluation number of the pressure comfort of the upholstered element is determined therefrom according to a specific computational rule. When the comfort evaluation number is determined, different, anthropomorphic sensation areas and different sensation thresholds are taken into account. The known method does in fact provide objective and reproducible evaluation numbers of the sitting comfort for different upholstered seat elements, which also correlate to the subjective comfort sensation of a plurality of test persons.

However, it has become apparent that this statically acquired comfort evaluation number is not representative of the dynamic sitting comfort of a seat. That is to say a seat which has good evaluation with respect to the static sitting comfort does not necessarily also have to be felt to have an optimum degree of comfort when subjected to dynamic seat loading, for example when traveling with the respective vehicle over bad stretches of road. The assessment of an upholstered seat element when subjected to dynamic seat loading is clearly defined by completely different criteria than testing of the comfort of upholstered seat elements in the case of static sitting.

The seat loading body disclosed in German Patent Document DE 197 20 854 C1 (referred to below as [1]) and the seat loading body according to German Patent Document DE 198 07 751 C1 which is developed further in terms of technical oscillation considerations (referred to below as [3]) deal with the particular problems of the testing of the comfort of upholstered seat elements in terms of dynamic criteria. The seat loading body according to [1] which is also of anthropomorphic design is freely movable and corresponds to the sitting weight of an average person. In order to obtain the necessary sitting weight of the seat loading body, a passive ballast in the form of a plurality of weights is attached on the inside of the posterior simulator and/or to the back simulator. The intention is that the freely movable seat loading body will be used to measure oscillations, independently of persons, on vehicle seats, which are comparable at least qualitatively with corresponding test person measurements in the overall spectral range from 0 to approximately 30 Hz. Similarly to the seat test ram described above for static examinations of seats, in the case of the freely movable seat loading body, the posterior simulator and the back simulator are also each formed by hard parts which are covered with upholstery, the latter simulating, at least on the underside and at the rear, the human skeleton in a way which is realistic. The coverage of the hard parts with upholstery simulates anthropomorphically, according to the thickness of layers, softness, elasticity and damping behavior as well as local distribution of these parameters, the soft parts in the posterior area or back area. Thus the coupling of the seat loading body, in terms of technical oscillation considerations, to the upholstered seat element and upholstered back rest element simulates as precisely as possible the corresponding junction point between the person and the upholstered elements. This is considered, according to [1], the predominant precondition in a representative measurement of oscillation, it also being assumed to be important that the seat loading body brings about not only a deformation of the surface of the upholstered element which corresponds to a natural person sitting on it, but also a distribution of the sitting pressure which corresponds to a natural person sitting on it. Intrinsic dynamic influences of individual body parts or body areas are considered, according to [1], to be secondary in comparison with coupling of the seat loading area to the upholstered elements of the vehicle seat in a way which is close to reality in terms of technical oscillation considerations, i.e. is anthropomorphically “soft”.

So that dynamic influences of the inherently oscillating body mass can be simulated under conditions close to reality during examinations of vehicle seats with respect to technical oscillation considerations, and can be registered as a result, in the further-developed seat loading body according to [3] the integrated ballast weights are constructed in the form of spring/damper/mass systems which are capable of oscillating in three dimensions. In each case, at least one oscillatory mass is surrounded by a spring/damper medium in such a way that the mass cannot oscillate in all three spatial directions.

The seat loading body according to [1] and [3] have the following in common: the simulation of the back is mounted so as to be capable of pivoting about the hip joint within a limited angular space relative to the posterior simulator, and is prestressed elastically in the sense of an extended position of the back part and posterior part. The thigh simulators of the posterior part are formed as far as the knee joint, lower leg simulators and foot simulators being connected in a movable fashion in the knee joint area and being able to support themselves movably on the floor. The weights of the passive ballast are distributed within the seat loading body in such a way that the overall supporting force in the contact surface of the posterior part and upholstered seat element and the local distribution of the sitting pressure corresponds to the supporting force and the distribution of sitting pressure when a natural test person is seated. Additionally an approximately identical position of the centre of gravity and/or an approximately equally large moment of mass inertia is produced at least about an axis which is parallel with the hip joint.

In order to carry out seat examinations with respect to technical oscillation considerations, the vehicle seat which is to be tested is attached, according to [1], on an oscillation platform which can be excited so as to experience vertical sinusoidal oscillations in the frequency range of 0-30 Hz. The seat loading body is then placed on the vehicle seat with optimum distribution of the sitting pressure, and low-mass acceleration sensors are positioned between the sitting surface and the seat loading body which is placed in the optimum sitting position. When the seat is excited so as to oscillate using the placed-on seat loading body with a defined frequency and defined acceleration amplitude, the response oscillation of the oscillation system which is formed from the seat and seat loading body to be tested can then be determined for each individual excitation oscillation or excitation frequency using the inserted acceleration sensors. In such an examination of a vehicle seat with respect to technical oscillation considerations, the spectral distribution of the vertical oscillations of the seat loading body are determined. The frequency response of the vehicle seat is, at it were, determined as a spectral diagram line under loading by the seat loading body. This line represents only the oscillation-damping behavior of a vehicle seat in its entirety with respect to a person sitting on it. Although this is a usable criterion for the evaluation of dynamic comfort properties of vehicle seats, the global damping behavior of the seat as a whole cannot be used to evaluate the more or less unpleasant oscillation sensation of a person who is sitting on a dynamically excited vehicle seat.

The object of the invention is to specify a method which, when the comfort of vehicle seats is examined, provides a quantitive, reproducible evaluation number, under conditions close to reality, which relates to the more or less unpleasant oscillation sensation of a human who is sitting on a dynamically excited vehicle seat. The dynamic oscillation excitation of the vehicle seat corresponds to the dynamic seat loading, for example when traveling with the respective vehicle over a bad stretch of road.

According to the present invention the entire sitting force of the seat loading body on the upholstered seat element is determined as an integral of the distribution of the sitting pressure in the frequency range of 0-30 Hz which is of interest here, without inertia for each point in time of the response oscillation of the system which is capable of oscillating. When the data are evaluated, the frequency response of the system which is capable of oscillating, i.e. the spectral distribution of the oscillation amplitudes of the response oscillation, is firstly determined, and the integral of this function up to a specific maximum frequency, for example 20 Hz or 25 Hz, is formed therefrom, this integral value being used as an evaluation number of the dynamic sitting comfort of the upholstered seat element. This evaluation number represents the oscillation loading of the sitting area of the human body when it sits on a vehicle seat which is excited so as to oscillate. If the aforesaid integral value of the frequency response curve is large, this means a large degree of oscillation loading of the human body by the respective vehicle seat, i.e. this seat is felt to be uncomfortable over time. On the other hand, vehicle seats with a low integral value are felt to be more pleasant when traveling on bad stretches of road.

While the method which is known from publication [1] or publication [3] for carrying out examinations of seats with respect to technical oscillation considerations reveals the damping property of the upholstered seat element for oscillations, i.e. a property which can be attributed to the upholstered seat element in isolation, the method according to the present invention makes possible an evaluation which relates to the interaction between a person and the upholstered seat element and which corresponds to the sensation of the person in response to excited seat oscillations.

### BRIEF DESCRIPTION OF THE DRAWINGS

The invention is explained below by means of an exemplary embodiment which is illustrated in the drawing, in which:

FIG. 1 shows a body, which is placed on a vehicle seat and is of anthropomorphic design in the posterior area and back area and has full lower limb dimensions in order to permit the thigh simulators to be supported on the floor, as well as a flexible measuring mat which is applied in the sitting area,

FIG. 2 shows the grid division of the flexible measuring mat and the indication of the selected force measuring sensors,

FIG. 3 shows, in a highly schematic fashion, the measuring setup during a measuring journey on a bad stretch of road,

FIGS. 4a, 4b and 4c show the measuring record of the time profile of the seat loading for a hard vehicle seat (FIG. 4a), a normal vehicle seat (FIG. 4b) and for a soft vehicle seat (FIG. 4c), obtained during a measuring journey

FIG. 5 shows the diagrams of a Fourier frequency transformation (FFT) of the three profiles according to FIGS. 4a, 4b and 4c, and

FIG. 6 shows the integral functions of the three FFT diagrams according to FIG. 5.

### DETAILED DESCRIPTION OF THE PREFERRED EMBODIMENT

The method for determining an evaluation for the quality of the dynamic sitting comfort of upholstered seat elements 2, 3 of a road vehicle 25 can be carried out in various ways within the scope of the invention. In all cases, the vehicle seat 1 to be tested must be loaded under conditions close to reality and excited so as to oscillate. There are a number of possibilities in terms of the loading, but even more in terms of the excitation so as to oscillate.

The loading of the vehicle seat 1 to be tested can be carried out by a test person or by a test body 15 which is of anthropomorphic design with respect to sitting. The loading by a test person has the advantage that such a test person is almost always readily available, in particular without previous investment. However, the use of test persons has the disadvantage that the tests cannot always be carried out with the same test person and as a result the measurement results are not readily comparable with one another. For this reason, the loading of the vehicle seat to be tested with a test body of anthropomorphic design is to be recommended despite the investment which is necessary.

In particular concerning the excitation of oscillations of the body/seat system which is formed in this way and is capable of oscillating, there are different possibilities in this respect. Specifically, the system which is capable of oscillating and is formed from the seat loading body and vehicle seat can be excited in isolation in order to make it oscillate, for example on an oscillation test stand for vehicle seats or in the installed state in the respective vehicle 25. The latter alternative is preferably recommended since the intrinsic oscillation behavior of the vehicle is then in fact included in the result of the measurement of oscillations. The same vehicle seat, which gives rise to good measurement results when there are oscillation measurements in one type of vehicle, i.e. was evaluated as a very comfortable seat in terms of oscillation in this type of vehicle, is not required to produce an equally good comfort evaluation when tested in another type of vehicle. The excitation of the vehicle so as to oscillate can itself be carried out under conditions close to reality in such an examination by traveling over a bad stretch of road or on what is referred to as a shaking test bench in which each of the four wheel hubs of the vehicle are attached to one shaker each, and the four shakers are excited, in a program-controlled fashion and with assigned phase, so as to oscillate under conditions close to reality in accordance with traveling over a bad stretch of road. Traveling over a bad stretch of road does not require the investment in an expensive vehicle shaking test stand. On the other hand, a precondition for excitation of oscillating by traveling over a bad stretch of road is that the test journey can always be carried out over the same road and the same stretch on it and always under the same travel conditions such as state of the road (dry), speed (constant, approximately 60 km/h), straight-ahead travel, which is under certain circumstances possible only with certain restrictions. In addition, an oscillation test of vehicle seats at different development locations by traveling over a bad stretch of road which is respectively available locally, i.e. different bad stretches of road, may lead under certain circumstances to slightly different measurement results. In any case, excitation of oscillating by traveling over a bad stretch of road is problematic if the same vehicle seat is to be tested by different development teams which operate far apart from one another in terms of location. In such a case, it is instead recommended to carry out excitation of oscillating in each case by means of a vehicle shaking test stand which can be provided with the same excitation program at both locations.

When the vehicle seat is examined with respect to oscillation, the system which is capable of oscillating and is formed from the seat loading body and vehicle seat can, as stated, also be excited to oscillate in the desired spectrum by means of a seat test stand. This excitation possibility is advantageous in that the investment expenditure on such a test stand is relatively low in comparison with a vehicle shaking test stand. In addition, oscillation of the vehicle seat with respect to oscillation is carried out in a building, independently of the weather, and always under the same conditions. There are in turn various possibilities for excitation of oscillating by means of a seat test stand.

Specifically, the body/seat system can be excited by means of sinusoidal oscillations, the excitation frequency changing slowly, i.e. quasi-statically and being adjusted through the desired spectrum from 0 to 30 Hz. The amplitudes of the response oscillation which are respectively set to the excitation of oscillating are recorded at the same time as a function of the excitation frequency. This amplitude/frequency record constitutes the frequency response of the body/seat system which is capable of oscillating.

On the other hand, the body/seat system can be excited by the seat test stand using a stochastic mixture of oscillations which changes over time. The stochastic excitation oscillation was measured in advance on a measuring journey over a bad stretch of road. The stochastic excitation of the body/seat system must be maintained for a certain time and the likewise stochastic response oscillation of the system must be recorded. By means of a Fourier frequency transformation, the frequency response of the body/seat system which is capable of oscillating, and which is of interest here, is determined from the time profile from the response oscillation.

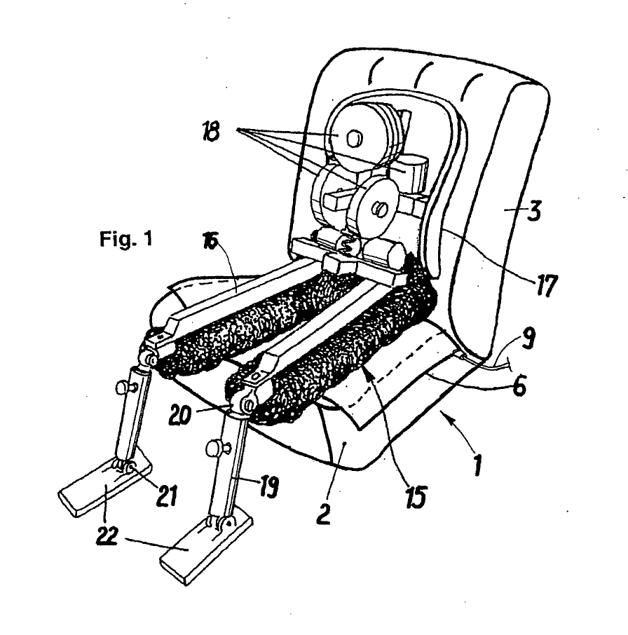

In the exemplary embodiment illustrated in FIG. 1, the vehicle seat 1 is loaded during the examination with respect to oscillation by means of a freely movable test body 15 of anthropomorphic design which, with the intermediate positioning of a measuring mat 6 which is applied to the upholstered seat element 2 in a defined position, is itself also placed on the upholstered seat element in a defined position and rested against the upholstered back rest element 3.

The test body 15 is composed of a thigh and posterior area 16 which is covered with upholstery, of a back area 17 which is connected in an articulated fashion thereto at the hip joint and is also covered with upholstery, and of a pair of lower leg simulators 19 which are connected to the thigh simulators in the knee joint area 20 in an articulated fashion and are supported on the floor by means of footplates 22 which are connected in an articulated fashion 21. The hard parts of the thigh and posterior area 16 and those of the back area 17 realistically simulate, at least on the underside and the bearing side, the shape of the pelvic bone and of the thighs including the thigh joints of a human skeleton. The coverage of the hard parts with upholstery simulates, as realistically as possible, the natural soft parts in the posterior area and back area in terms of the layer thickness, softness, elasticity and damping behavior as well as local distribution of these parameters, in particular in the area of the two sitting pressure points. In addition, in order to obtain the necessary sitting weight, the test body 15 which is of anthropomorphic design is provided with a plurality of ballast weights 18 which are attached to the thigh and posterior area 16 and/or are secured on the inside of the back area 17.

The test body is expediently configured in terms of its proportions and its weight in such a way that it corresponds to the average of all male persons, i.e. a 50 percentile man. Women do have different proportions in the posterior area from men so that it may appear advantageous to carry out measurements with a female 50 percentile test body in addition to the measurements with a male 50 percentile test body. The differences are, however, less significant in comparison with the differences between a 50 percentile man and a very large 95 percentile man or with respect to a very small 5 percentile man. Comparative measurements with a male and a female 50 percentile test body would therefore presumably only reveal marginal differences in the measurement result, which would probably not, at least not to a significant extent, lie outside the normal measuring inaccuracy or measuring variation. At any rate, it could be expedient to make the measurement result somewhat more reliable by carrying out multiple measurements using a male and a female 50 percentile test body and forming a mean value from the final values of the individual measurements. Such safeguarding of the measured values could also be extended as desired by multiple measurements not only of male and female 50 percentile test bodies but also with 5 percentile test bodies and 95 percentile test bodies, respectively male and female, and by a subsequent formation of mean values.

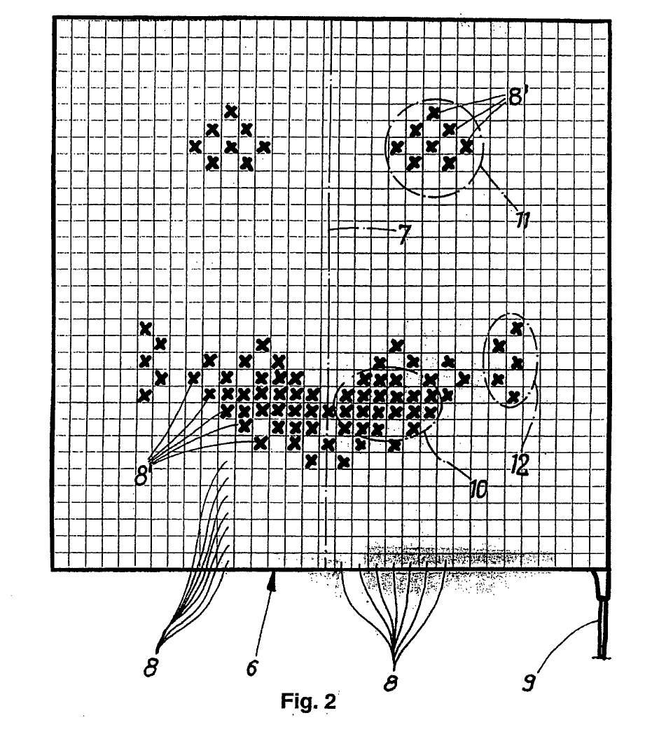

The flexible measuring mat 6 which is necessary to examine the vehicle seat with respect to oscillation and is applied to the upholstered seat element of the vehicle seat in a defined position is provided with a plurality of separate force measuring sensors 8 which are each also inherently more flexible. The force measuring sensors which are integrated into the measuring mat are grid-like and distributed in it to cover the surface. In the exemplary embodiment illustrated in FIG. 2, the force measuring sensors 6, which are square in terms of the surface they require, are indicated by a checker-board-like line grid; along each side of the measuring mat. In each case 32 fields are provided so that the measuring mat contains 32×32=1024 force measuring sensors. In order for the measuring mat to be suitable for investigations of oscillation it is a precondition that the force measuring sensors each operate virtually without hysteresis up to a frequency of approximately 25 Hz. The force measuring sensors operate according to the capacitive principle. The opposite poles of each sensor are each provided with a signal terminal which leads outside to the evaluation device. However, each individual force measuring sensor does not need to be provided with a separate pair of line terminals. Instead it is sufficient if the poles of the force measuring sensors which lie on the one side of the mat are connected to one another in rows by a first set of lines, and the poles which lie on the opposite side of the mat are connected to one another in columns by a second set of lines, and this total of 2×32=64 lines are lead outwards in an insulated fashion in a corresponding four-conductor connecting cable 9. Each individual force sensor can be addressed independently by different pairing of the first and second lines.

The signal outputs of the force measuring sensors must be sampled with a sampling frequency of approximately 100 Hz in order to acquire sufficient measuring points within an oscillation cycle even at the relatively high frequencies of the response oscillation which are of interest. It is not necessary to evaluate the measuring signals of all the 1024 force measuring sensors of the measuring mat. Given the current state of computer technology and with the aforesaid sampling frequency this would result in unacceptably high demands being made of the evaluation unit with respect to computing capacity and computing speed. Instead, an appropriate local selection of force measuring sensors has reduced the number thereof to approximately 70 to 90 items, that is to say to a degree which can already be readily processed today by means of mobile computers (laptops) given the aforesaid sampling frequency. In the exemplary embodiment shown in FIG. 2, 76 sensors 8′ of the measuring mat are active.

It is conceivable to have a uniform distribution of the selected “active” force measuring sensors over the measuring mat, which also produces usable measuring results. However, the measurements are clearer if the selected force measuring sensors 8′ are concentrated in the mainly loaded areas, and here in turn in the ischial tuberosity area 10. Given a satisfactory arrangement of the measuring mat on the vehicle seat and of the test body on the measuring mat, the load fields extend symmetrically with respect to the center line 7 of the measuring mat. Here, in addition to the two ischial tuberosity areas 10, which take up the main load, there are also two side cheek areas 12 and two lower leg areas as well as a coccyx area. The seat edge area 11 indicated in FIG. 2 constitutes the front part of the lower leg area.

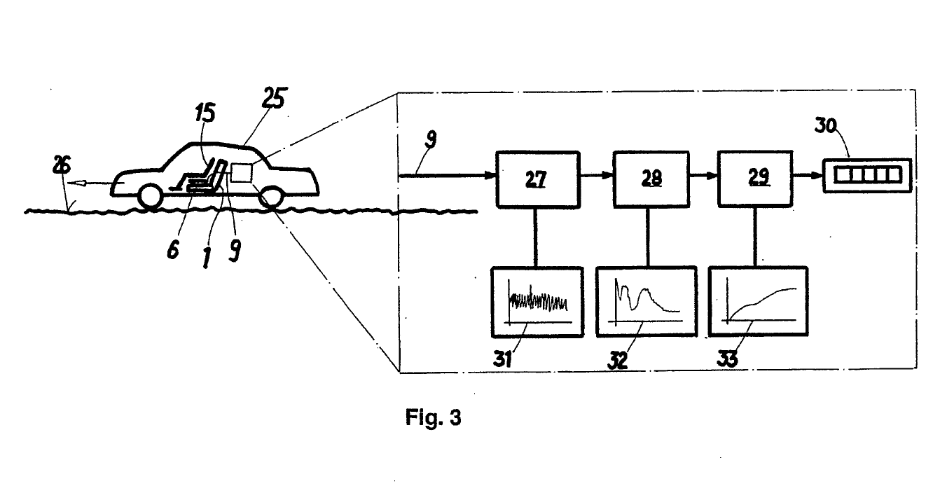

After the vehicle seat 1 has been installed satisfactorily in the respective road vehicle 25 (FIG. 3) and has been prepared with the measuring mat 6 and after the anthropomorphic test body 15 has been correctly positioned on it and secured on the upholstered back rest element 3 by means of a seat belt, the signal terminals of the force measuring sensors 8′ (connecting cables 9) are connected to the evaluation unit. In the exemplary embodiment illustrated in FIG. 3, the evaluation unit is composed essentially of a computer 27, an FFT analyzer 28, an integrator 29 and an end display 30. Before the measurement, it is necessary to check once more whether the test body 15 is seated correctly, which can be done by checking the static weight display before excitation of oscillating. To be specific, the actual overall force of all the selected force measuring sensors 8′ must coincide to a set point overall force which is determined in advance for the seat loading body used. If appropriate, the sitting position of the seat loading body on the vehicle seat 1 must be corrected until a set point/actual correspondence is obtained. If a natural test person is used as the seat loading body, the measurement must also not be started until the measuring mat has assumed body heat, which is the case at the earliest after approximately 5 to 7 minutes.

In the exemplary embodiment illustrated in FIG. 3, in order to carry out a measurement the body/seat system is excited to oscillate stochastically by traveling with the vehicle 25 over a bad stretch 26 of road so that excitation oscillations within the frequency range of 0 to 30 Hz which are of interest here are also included. The signals which are present at the force measuring sensors during the excitation time are evaluated in real time in the aforesaid evaluation unit 27-30. It is also conceivable instead to record merely the time profile of the individual signals and later carry out the evaluation offline in a laboratory where more computing time is available.

The measuring journey on the bad stretch 26 of road is to be carried out under the same conditions for all the measurements, specifically straight-ahead travel with constant speed of approximately 50 to 60 km/h on a dry underlying surface. The measuring travel is carried out over a measuring time of at least approximately 5 minutes. If a straight stretch of bad road of approximately five km in length is not available, a shorter part of a straight bad stretch 26 of road is traveled along backward and forward repeatedly, the measuring signals and their processing being suppressed during the turning maneuver.

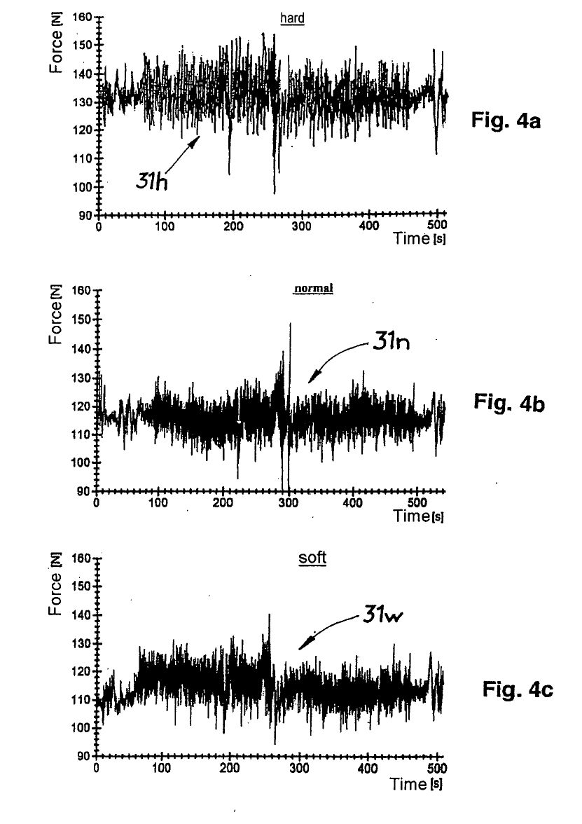

When the measuring signals are processed, the signals of all the force measuring sensors 8 are in all cases added at least approximately with the same phase to form a composite signal 31, which takes place in the computer 27. FIGS. 4a, 4b and 4c each show a force profile which has been recorded on a hard vehicle seat (FIG. 4a; composite signal 31h), on a normal vehicle seat (FIG. 4b; composite signal 31n) and on a soft vehicle seat (FIG. 4c; composite signal 31w).

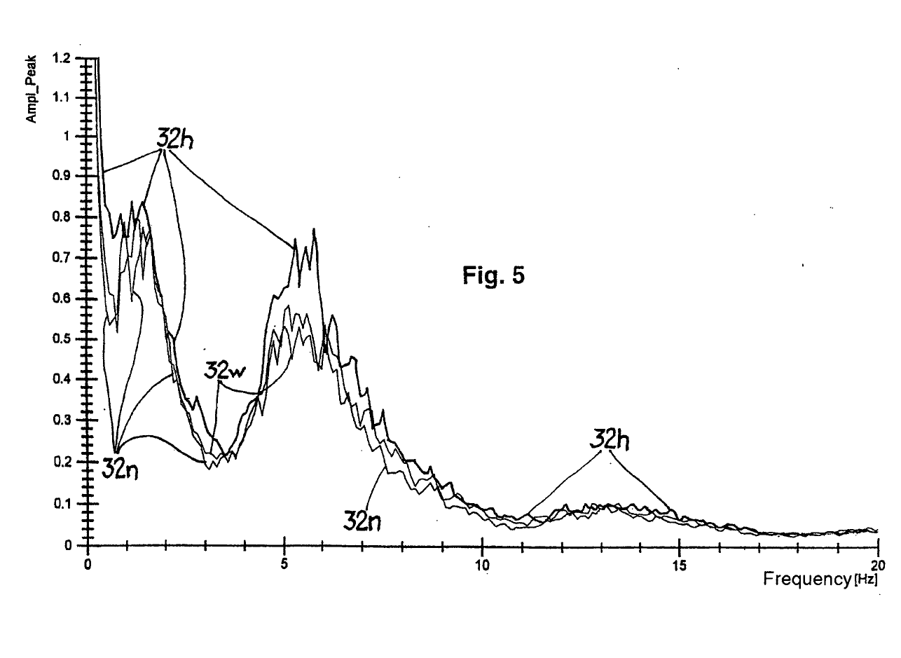

The spectral distribution of the amplitudes of the response oscillation of the body/seat system, referred to as the frequency response 32, is determined from the time profile of this composite signal 31 by means of the FFT analyzer 28. The various frequency responses 32h, 32n and 32w of the hard vehicle seat, of the normal vehicle seat and of the soft vehicle seat are illustrated in a direct comparison in FIG. 5. Although the differences are not yet very striking, their tendency is recognizable despite certain systematic correspondences of the frequency responses, for example with respect to the spectral position of the resonant points. The increasing resonance at the resonant point 5 Hz is significantly greater with a hard seat than with a soft seat or with a normal seat. The tendency of the profile of the frequency response 32n of the normal seat is at the lowest level overall.

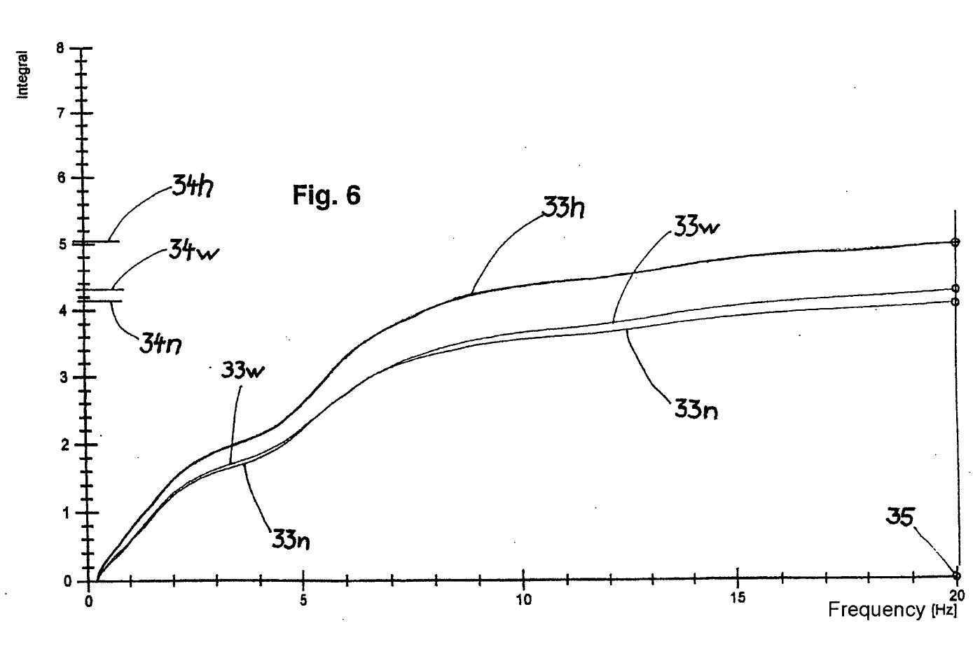

In the integrator 29, the ratio of the area integral 33 of this frequency response is determined up to a certain limit frequency 35, the limit value 34h, 34n, 34w of this ratio of the area integral 33h, 33n, 33w at the limit frequency 35, in the example 20 Hz, being used as an evaluation number of the dynamic sitting comfort of the upholstered element of the vehicle seat 1. The integral lines 33h, 33n and 33w of the hard seat, of the normal seat and of the soft seat (FIG. 6) allow the differences between the various seats to be recognized more clearly than the frequency responses according to FIG. 5. In particular, by means of the limit value 34h, 34n or 34w it is possible to express the oscillation comfort of the respective vehicle seat in a comparable and reproducible fashion merely by a numerical value.

It is an advantage of the invention in comparison with the measuring method known from [1] that an easily comparable evaluation number is acquired as a result of the measurement, which number is not only representative of the criterion of the seat to be measured but also can be reproduced during later measurements with only a small degree of variation. A further important advantage of the measuring method according to the invention over the prior art is that the invention actually registers the sensitivity of the human body to seat oscillations using measuring technology, i.e. by means of the acquired comfort evaluation number it is possible to obtain quantitive and comparable definitive information on the oscillation loading on the human body by the respective vehicle seat during a relatively long journey, which was previously impossible.

1-11. (canceled)

12. A method for determining an evaluation number which is representative of a quality of the dynamic sitting comfort of upholstered elements of a vehicle seat, said method comprising the steps:
applying a flexible measuring mat to the upholstered seat element of the vehicle seat in a defined position, said measuring mat being provided with a plurality of separate force measuring sensors which are integrated into the measuring mat, are distributed in the manner of a grid so as to cover a surface of the mat, are also each inherently flexible, are each operate virtually without hysteresis up to a frequency of approximately 25 Hz and are each provided with signal terminals which lead outwards to an evaluation device;
subsequently loading the vehicle seat with a seat loading body under conditions close to reality;
positioning said seat loading body in a defined position, centrally on the vehicle seat, wherein said seat loading body is one of a natural test person and a freely movable test body which is designed so as to be anthropomorphic with respect to the oscillatory behavior of the vehicle seat;
exciting a system formed by the seat and the body so as to oscillate at least within a frequency range of 0 to 30 Hz;
at least one of recording and analyzing signals which are present at signal terminals of the force measuring sensors during the excitation where the signals of all the force measuring sensors are added at least approximately with the same phase to form a composite signal;
determining the spectral distribution of the amplitudes of a response oscillation of the body/seat system from the time profile of said composite signal; and
determining a ratio of an area integral of said frequency response up to a specific limit frequency; using a limit value of said ratio of the area integral being used at the limit frequency as said evaluation number of the dynamic sitting comfort of the upholstered element of the vehicle seat.

13. The method as claimed in claim 12, wherein the freely movable test body is of an anthropomorphic design and comprises a thigh and posterior area covered with upholstery a back area connected at the hip joint in an articulated fashion and is covered with upholstery, and a pair of lower leg simulators connected to the thigh simulators in the knee joint area (20) in an articulated fashion and supported on the floor by means of footplates which are connected in an articulated fashion, wherein hard parts of the thigh and posterior area and the back area simulating as true to nature as possible, at least on the underside and the bearing side, the shape of the pelvic bone and of the thighs including the thigh joints of a human skeleton, and wherein the coverage of the hard parts with upholstery simulating as true to nature as possible the natural soft parts in the posterior area and back area in accordance with the layer thickness, softness, elasticity and damping behavior as well as local distribution of these parameters in the area of the two sitting pressure points, wherein the freely movable test body which is of anthropomorphic design is also provided with passive ballast in the form of a plurality of ballast weights which are at least one of inserted on the inside into the thigh and posterior area and secured to the inside of the back area in order to obtain the necessary sitting weight.

14. The method as claimed in claim 12, wherein the body/seat system is excited by means of stochastic oscillations, and the spectral distribution is determined from the composite signal of the response oscillation by means of a Fourier frequency transformation.

15. The method as claimed in claim 14, wherein the vehicle seat to be evaluated with respect to its dynamic sitting comfort is installed according to predetermined regulations in the vehicle, and wherein the body/seat system is excited stochastically to oscillate by the wheels of the vehicle.

16. The method as claimed in claim 15, wherein the stochastic excitation of oscillations takes place as a result of the vehicle traveling over a defined road.

17. The method as claimed in claim 12, wherein approximately 70 to 100 force measuring sensors are selected from the plurality of force measuring sensors integrated into the measuring mat and only signals of said selected sensors are further processed, wherein the selected force measuring sensors being preferably arranged in an ischial tuberosity area.

18. The method as claimed in claim 12, wherein, before the step of exciting the system, a checking is carried out to determine whether the actual overall force of all the force measuring sensors corresponds to a set point overall force which is determined in advance for the seat loading body used, the sitting position of the seat loading body on the vehicle seat is corrected until a set point/actual correspondence is brought about.

19. The method as claimed in claim 12, wherein when a person is used as the seat loading body, the measurement of oscillations is not started until the measuring mat has assumed body heat.

20. The method as claimed in claim 16, wherein a measuring journey on said defined road is carried out with straight-ahead travel at a constant speed of approximately 50 to 60 km/h on a dry underlying surface.

21. The method as claimed in claim 20, wherein a measuring journey is carried out over a measuring time of at least approximately 5 minutes.

22. The method as claimed in claim 16, wherein if a straight portion of said of road of approximately 5 km in length is not available, a shorter part of a straight portion of road is traveled over repeatedly backward and forward, the measuring signals and their processing being suppressed during a turning maneuver.

23. A system for determining relative quality of dynamic comfort of upholstered elements of a vehicle seat, said system comprising:
a flexible measuring mat applied to an upholstered seat element in a defined position wherein said flexible measuring mat includes a plurality of forced measuring sensor distributed as a grid to cover a surface of the mat, wherein each of said sensors are flexible and operate without hysteresis to a frequency of approximately 25 Hz and wherein each of said sensors are provided with an output terminal;
an evaluation device connected to received output signals from each of said output of said measuring devices;
an excitation device for oscillating said seat and said measuring mat within a range of frequency between 0 and substantially 30 Hz;
a measuring system for measuring and analyzing outputs of said measuring sensors including means for adding at least approximately within the same phase a force measuring sensor output to form a composite signal and performing a spectral distribution of amplitudes of response oscillations of a system formed by said seat and said mat from the time profile of said composite signals;
means for determining a ratio of an area integral of said frequency response to a specific limit frequency when a limit value of said ratio of the area integral at the limit frequency provides an evaluation number indicating said quality.

24. The system according to claim 12, further including a test body providing on said flexible mat.
